(19) United States
(12) Patent Application Publication
(10) Pub. No.: US 2022/0008921 A1
(43) Pub. Date: Jan. 13, 2022

(54) SPATIAL AND TEMPORAL NECKING FOR ROBUST MULTI-SIZE DISPENSING OF LIQUIDS ON HIGH ELECTRODE DENSITY ELECTRO-WETTING ARRAYS

(71) Applicant: Nuclera Nucleics Ltd., Cambridge (GB)

(72) Inventor: DAVID ZHITOMIRSKY, Woburn, MA (US)

(21) Appl. No.: 17/334,314

(22) Filed: May 28, 2021

Related U.S. Application Data
(60) Provisional application No. 63/031,000, filed on May 28, 2020.

(51) Int. Cl. B01L 3/00

(52) U.S. Cl. CPC B01L 3/502715; B01L 3/502792; B01L 3/50273; B01L 2300/089; B01L 2200/16; B01L 2300/0819; B01L 2400/0427

(57) ABSTRACT

A digital microfluidic system, comprising: (a) a bottom plate comprising an electrode array comprising a plurality of digital microfluidic propulsion electrodes; (b) a top plate comprising a common top electrode; (c) a controller coupled to the processing unit, common top electrode, and bottom electrode array; and (d) a processing unit operably programmed to: receiving input instructions relating to a droplet diameter and aspect ratio; calculating actuation parameters comprising: a length of an actuated hold, a length of an actuated neck, and a height of an actuated head, for dispensing a droplet having the diameter and aspect ratio of the input instructions; outputting electrode actuation to the controller, the electrode actuation instructions relating to a dispense driving sequence for implementing the calculated actuation parameters, to dispense having the input diameter and aspect ratio; wherein the electrodes have a dimension less than the diameter of the droplet.

### CROSS-REFERENCE TO RELATED PATENT APPLICATIONS

This application claims priority to U.S. Provisional Application No. 63/031,000 filed on May 28, 2020 the entire content of which is hereby incorporated by reference in its entirety.

### BACKGROUND

Digital microfluidic devices use independent electrodes to propel, split, and join droplets in a confined environment, thereby providing a “lab-on-a-chip”. Digital microfluidic devices are alternatively referred to as electrowetting on dielectric, or “EWoD,” to further differentiate the method from competing microfluidic systems that rely on electrophoretic flow and/or micropumps. A 2012 review of the electrowetting technology was provided by Wheeler in “Digital Microfluidics,” Annu. Rev. Anal. Chem. 2012, 5:413-40, which is incorporated herein by reference in its entirety. The technique allows sample preparation, assays, and synthetic chemistry to be performed with tiny quantities of both samples and reagents. In recent years, controlled droplet manipulation in microfluidic cells using electrowetting has become commercially-viable, and there are now products available from large life science companies, such as Oxford Nanopore.

Most of the literature reports on EWoD involve so-called “passive matrix” devices (a.k.a. “segmented” devices), whereby ten to twenty electrodes are directly driven with a controller. While segmented devices are easy to fabricate, the number of electrodes is limited by space and driving constraints. Accordingly, it is not possible to perform massive parallel assays, reactions, etc. in passive matrix devices. In comparison, “active matrix” devices (a.k.a. active matrix EWoD, a.k.a. AM-EWoD) devices can have many thousands, hundreds of thousands or even millions of addressable electrodes. The electrodes are typically switched by thin-film transistors (TFTs) and droplet motion is programmable so that AM-EWoD arrays can be used as general purpose devices that allow great freedom for controlling multiple droplets and executing simultaneous analytical processes.

Digital microfluidic systems are designed with biological or chemical applications in mind. These often require large quantities of liquids to be introduced as reservoirs onto the device, and then subsequently dispensed in smaller amounts to carry out reactions or other functions. Traditionally, dispensing is achieved by having a large segmented reservoir, and then using a sequence of steps to dispense a droplet on a one-size track. The basic procedure for dispensing usually begins by extending a line of liquid from the reservoir. Then, a thin neck is formed between the reservoir and the incipient droplet and the reservoir and droplet are moved in opposite directions. This approach is useful but often suffers from reproducibility due to large variations in reservoir volume, and is limited to dispensing only a single size of droplet due to the architecture of the rest of the array. For example, International Publication WO 2008/124846 describes a general methodology for stretching a drop of fluid into a neck and then cleaving off a daughter droplet. Its system relies on a segmented array where there is no choice for the size of the resulting droplet. Multi-segmented structures are used for the reservoir zone, but only a one segment wide lane is used to dispense the droplets. Nikapitiya et al. (Micro and Nano Syst Lett (2017) 5:24) developed a methodology using special structures to achieve a coefficient of variation (CV) below 1%. The innovative aspect is in how the neck is formed and how the droplet is cleaved (along a diagonal), thereby resulting in a cleaner, reproducible symmetry for cleaving. However, the design is segmented and limited to a fixed droplet size.

Cho et al. (Journal of Microelectromechanical Systems, Volume: 12, Issue: 1, February 2003) provide a physical analysis of how basic droplet operations occur on an electrowetting device and uses the physical parameters of the electrowetting system, such as dielectric constants, voltages, and thickness, to define which parameters need to be adjusted to maximize the efficiency of each operation. In particular, the reference describes the requirements for neck formation in relation to the splitting electrodes and a number of parameters. U.S. Pat. No. 8,936,708 describes a method by which smaller drops may be split off from larger drops. The reference predominantly deals with defining a prototype having pixels of different geometric shapes, e.g., hexagonal, and how to split droplets across such pixels. However, no precise method for systematic dispensing of differently sized droplets is provided. U.S. Pat. No. 8,834,695 discusses the possibility of using small electrodes to formulate larger patterns that can act as a dispensing reservoir. The methodology for size control makes use of accumulating small droplets into larger ones, but provides no systematic and efficient dispensing of droplets having variable sizes nor any focus on methods for improving the CV.

### SUMMARY

In a first aspect, the present application addresses the shortcomings of the prior art by providing an alternate method of dispensing a droplet on a digital microfluidic system, the system comprising: (a) a bottom plate comprising: a bottom electrode array comprising a plurality of digital microfluidic propulsion electrodes; and a first dielectric layer covering the bottom electrode array; (b) a top plate comprising: a common top electrode; and a second dielectric layer covering the common top electrode; (c) a processing unit operably programmed to perform a microfluidic driving method; and; and (d) a controller operatively coupled to the processing unit, common top electrode, and bottom electrode array, wherein the controller is configured to provide propulsion voltages between the common top electrode and the bottom plate propulsion electrodes. The method comprises: receiving input instructions in the processing unit, the input instructions relating to a droplet diameter and aspect ratio; calculating in the processing unit actuation parameters comprising: a length of an actuated hold, a length of an actuated neck, and a height of an actuated head, for dispensing a droplet having the diameter and aspect ratio of the input instructions; outputting electrode actuation instructions from the processing unit to the controller, the electrode actuation instructions relating to a dispense driving sequence for implementing the calculated actuation parameters; executing the dispense driving sequence on the propulsion electrodes, to: shape a fluid in a reservoir to form an actuated hold and an actuated neck; cleaving the droplet from the head of the neck; and returning the neck fluid into the reservoir, wherein the electrodes have a dimension less than the diameter of the droplet.

In a second aspect, the present application provides a novel digital microfluidic system, comprising: (a) a bottom plate comprising: a bottom electrode array comprising a plurality of digital microfluidic propulsion electrodes; and a first dielectric layer covering the bottom electrode array; (b) a top plate comprising: a common top electrode; and a second dielectric layer covering the common top electrode; (c) a processing unit; and (d) a controller operatively coupled to the processing unit, common top electrode, and bottom electrode array, wherein the controller is configured to provide propulsion voltages between the common top electrode and the bottom plate propulsion electrodes. The processing unit is operably programmed to: receiving input instructions, the input instructions relating to a droplet diameter and aspect ratio; calculating actuation parameters comprising: a length of an actuated hold, a length of an actuated neck, and a height of an actuated head, for dispensing a droplet having the diameter and aspect ratio of the input instructions; outputting electrode actuation to the controller, the electrode actuation instructions relating to a dispense driving sequence for implementing the calculated actuation parameters, to dispense having the input diameter and aspect ratio; wherein the electrodes have a dimension less than the diameter of the droplet.

In a third aspect, herein provided is an improved method of dispensing a droplet on a digital microfluidic system, the method comprising extending a line of liquid from a reservoir, forming an actuated neck between the reservoir and the incipient droplet, and cleaving the droplet from the actuated head of the neck, the improvement comprising: increasing the height of the actuated head to an advanced cleave height before cleaving the droplet from the head.

### BRIEF DESCRIPTION OF DRAWINGS

FIG. 1 shows a traditional microfluidic device including a common top electrode.

FIG. 2 is a schematic diagram of a TFT architecture for a plurality of propulsion electrodes of an EWoD device.

FIG. 3 is a schematic diagram of a portion of a bottom plate TFT array, including a propulsion electrode, a thin film transistor, a storage capacitor, a dielectric layer, and a hydrophobic layer.

FIG. 4 is a schematic top view of a reservoir as defined by a high-density electrode grid.

FIG. 5A is a top view of the reservoir of FIG. 4, with the electrode grid no longer shown for clarity, and a first actuated neck height.

FIG. 5B is a top view of the reservoir of FIG. 4, with the electrode grid no longer shown for clarity, and a second actuated neck height.

FIG. 6 is a top view of the reservoir of FIG. 4 where actuation parameters for implementing a dispense driving sequence are identified.

FIG. 7 is a flow chart illustrating an example droplet dispense process according to the present application.

FIG. 8 is a schematic illustration of a droplet dispense pattern.

FIG. 9 schematically illustrates operations to center the fluid in a reservoir.

FIG. 10 illustrates the formation of the hold and neck.

FIG. 11 illustrates the cleaving of the droplet from the neck.

FIG. 12A illustrates a variation of the cleaving of the droplet where an extended “timed neck” is formed. FIG. 12B the effect of timed necking on the negative curvature radius at the pinching point.

FIG. 13A a variation of the cleaving of the droplet where the head height is increased to a larger advanced head height. FIG. 13B illustrates the effect of the advanced head height on the curvature radius at the pinching point.

FIG. 14 illustrates the mechanism of droplet cutting from the actuated neck.

FIG. 15A illustrates voltage patterns on active electrodes.

FIG. 15B illustrates inactive electrodes without voltage patterns.

Unless otherwise noted, the following terms have the meanings indicated.

“Actuate” with reference to one or more electrodes means effecting a change in the electrical state of the one or more electrodes which, in the presence of a droplet, results in a manipulation of the droplet.

“Droplet” means a volume of liquid that electrowets a hydrophobic surface and is at least partially bounded by carrier fluid. For example, a droplet may be completely surrounded by carrier fluid or may be bounded by carrier fluid and one or more surfaces of an EWoD device. Droplets may take a wide variety of shapes; non-limiting examples include generally disc shaped, slug shaped, truncated sphere, ellipsoid, spherical, partially compressed sphere, hemispherical, ovoid, cylindrical, and various shapes formed during droplet operations, such as merging or splitting or formed as a result of contact of such shapes with one or more working surface of an EWoD device. Droplets may include typical polar fluids such as water, as is the case for aqueous or non-aqueous compositions, or may be mixtures or emulsions including aqueous and non-aqueous components. The specific composition of a droplet is of no particular relevance, provided that it electrowets a hydrophobic working surface. In various embodiments, a droplet may include a biological sample, such as whole blood, lymphatic fluid, serum, plasma, sweat, tear, saliva, sputum, cerebrospinal fluid, amniotic fluid, seminal fluid, vaginal excretion, serous fluid, synovial fluid, pericardial fluid, peritoneal fluid, pleural fluid, transudates, exudates, cystic fluid, bile, urine, gastric fluid, intestinal fluid, fecal samples, liquids containing single or multiple cells, liquids containing organelles, fluidized tissues, fluidized organisms, liquids containing multi-celled organisms, biological swabs and biological washes. Moreover, a droplet may include one or more reagent, such as water, deionized water, saline solutions, acidic solutions, basic solutions, detergent solutions and/or buffers. Other examples of droplet contents include reagents, such as a reagent for a biochemical protocol, a nucleic acid amplification protocol, an affinity-based assay protocol, an enzymatic assay protocol, a gene sequencing protocol, a protein sequencing protocol, and/or a protocol for analyses of biological fluids. Further example of reagents include those used in biochemical synthetic methods, such as a reagent for synthesizing oligonucleotides finding applications in molecular biology and medicine, and/or one more nucleic acid molecules. The oligonucleotides may contain natural or chemically modified bases and are most commonly used as antisense oligonucleotides, small interfering therapeutic RNAs (siRNA) and their bioactive conjugates, primers for DNA sequencing and amplification, probes for detecting complementary DNA or RNA via molecular hybridization, tools for the targeted introduction of mutations and restriction sites in the context of technologies for gene editing such as CRISPR-Cas9, and for the synthesis of artificial genes by “synthesizing and stitching together” DNA fragments.

“Droplet operation” means any manipulation of one or more droplets on a microfluidic device. A droplet operation may, for example, include: loading a droplet into the microfluidic device; dispensing one or more droplets from a source droplet; splitting, separating or dividing a droplet into two or more droplets; transporting a droplet from one location to another in any direction; merging or combining two or more droplets into a single droplet; diluting a droplet; mixing a droplet; agitating a droplet; deforming a droplet; retaining a droplet in position; incubating a droplet; heating a droplet; vaporizing a droplet; cooling a droplet; disposing of a droplet; transporting a droplet out of a microfluidic device; other droplet operations described herein; and/or any combination of the foregoing. The terms “merge,” “merging,” “combine,” “combining” and the like are used to describe the creation of one droplet from two or more droplets. It should be understood that when such a term is used in reference to two or more droplets, any combination of droplet operations that are sufficient to result in the combination of the two or more droplets into one droplet may be used. For example, “merging droplet A with droplet B,” can be achieved by transporting droplet A into contact with a stationary droplet B, transporting droplet B into contact with a stationary droplet A, or transporting droplets A and B into contact with each other. The terms “splitting,” “separating” and “dividing” are not intended to imply any particular outcome with respect to volume of the resulting droplets (i.e., the volume of the resulting droplets can be the same or different) or number of resulting droplets (the number of resulting droplets may be 2, 3, 4, 5 or more). The term “mixing” refers to droplet operations which result in more homogenous distribution of one or more components within a droplet. Examples of “loading” droplet operations include microdialysis loading, pressure assisted loading, robotic loading, passive loading, and pipette loading. Droplet operations may be electrode-mediated. In some cases, droplet operations are further facilitated by the use of hydrophilic and/or hydrophobic regions on surfaces and/or by physical obstacles.

“Diameter,” when used in reference to a droplet, is intended to identify the longest straight line segment between two points on the droplet surface.

“Gate driver” is a power amplifier that accepts a low-power input from a controller, for instance a microcontroller integrated circuit (IC), and produces a high-current drive input for the gate of a high-power transistor such as a TFT. “Source driver” is a power amplifier producing a high-current drive input for the source of a high-power transistor. “Top electrode driver” is a power amplifier producing a drive input for a top plane electrode of an EWoD device.

“Nucleic acid molecule” is the overall name for DNA or RNA, either single- or double-stranded, sense or antisense. Such molecules are composed of nucleotides, which are the monomers made of three moieties: a 5-carbon sugar, a phosphate group and a nitrogenous base. If the sugar is a ribosyl, the polymer is RNA (ribonucleic acid); if the sugar is derived from ribose as deoxyribose, the polymer is DNA (deoxyribonucleic acid). Nucleic acid molecules vary in length, ranging from oligonucleotides of about 10 to 25 nucleotides which are commonly used in genetic testing, research, and forensics, to relatively long or very long prokaryotic and eukaryotic genes having sequences in the order of 1,000, 10,000 nucleotides or more. Their nucleotide residues may either be all naturally occurring or at least in part chemically modified, for example to slow down in vivo degradation. Modifications may be made to the molecule backbone, e.g. by introducing nucleoside organothiophosphate (PS) nucleotide residues. Another modification that is useful for medical applications of nucleic acid molecules is 2′ sugar modifications. Modifying the 2′ position sugar is believed to increase the effectiveness of therapeutic oligonucleotides by enhancing their target binding capabilities, specifically in antisense oligonucleotides therapies. Two of the most commonly used modifications are 2′-O-methyl and the 2′-Fluoro.

When a liquid in any form (e.g., a droplet or a continuous body, whether moving or stationary) is described as being “on”, “at”, or “over an electrode, array, matrix or surface, such liquid could be either in direct contact with the electrode/array/matrix/surface, or could be in contact with one or more layers or films that are interposed between the liquid and the electrode/array/matrix/surface.

When a droplet is described as being “on” or “loaded on” a microfluidic device, it should be understood that the droplet is arranged on the device in a manner which facilitates using the device to conduct one or more droplet operations on the droplet, the droplet is arranged on the device in a manner which facilitates sensing of a property of or a signal from the droplet, and/or the droplet has been subjected to a droplet operation on the droplet actuator.

“Each,” when used in reference to a plurality of items, is intended to identify an individual item in the collection but does not necessarily refer to every item in the collection. Exceptions can occur if explicit disclosure or context clearly dictates otherwise.

Reference throughout this specification to “one embodiment,” “certain embodiments,” “one or more embodiments” or “an embodiment,” whether or not including the terms “exemplary” or “non-exclusive” preceding the term “embodiment,” means that a particular feature, structure, material, step, or characteristic described in connection with the embodiment is included in at least one embodiment of the present invention. Thus, the appearances of the phrases such as “in one or more embodiments,” “in certain embodiments,” “in one embodiment” or “in an embodiment” in various places throughout this specification are not necessarily referring to the same embodiment of the present invention. Furthermore, the particular features, structures, materials, steps, or characteristics may be combined in any suitable manner in one or more embodiments.

Within the context of a microfluidic device, the use of “top” and “bottom” is merely a convention as the locations of the two plates can be switched, and the devices can be oriented in a variety of ways, for example, the top and bottom plates can be roughly parallel while the overall device is oriented so that the plates are normal to a work surface (as opposed to parallel to the work surface as shown in the figures). The top or the bottom plates may include additional functionalities, such as heating by commercially available micro-heaters and thermocouples that are integrated with the microfluidic platform and/or temperature sensing.

### DETAILED DESCRIPTION

It would be greatly beneficial to have fine control over fluid volumes so as to dispense droplets efficiently and in various sizes. This capability would also enable the performance of complex droplet operations involving a multitude of droplet-borne reactants often combined in the context of processes featuring parallel reactions. Further, it is important that the reproducibility is high and size variation is kept to a minimum across all droplet sizes. Liquids may also come at different viscosity and have variable surface tensions that could greatly benefit from a highly tunable dispensing pattern. The present disclosure provides a methodology of dispensing droplets with high accuracy and reproducibility at variable sizes by using a high density electrode system, for example a thin electrode transistor (TFT) array. Importantly, this robust dispensing strategy is applicable to reservoirs that can cover several magnitudes of droplet volume, especially down to very small droplets.

The basic procedure for dispensing remains similar in certain aspects to literature reports, as discussed in the Background: first, a line of liquid is extended from the reservoir. Then, a thin neck is formed between the reservoir and the incipient droplet and the reservoir and droplet are moved in opposite directions. Traditional approaches are mostly based on segmented arrays with limited control over dispensing volumes and CV. This enables a limited degree of control over reservoir fluids due to the low density of reservoir electrodes. Also limited is the ability to control necking properties in more than one dimension as the electrode size is on the order of the droplet diameter. As a result, there is little ability to dispense fluids of different viscosities in variable droplet sizes.

In contrast, the present application defines reservoir and dispensing patterns that rely on a number of actuation parameters that may be dynamically adjusted based on variables such as the size of droplet, viscosity, and surface tension. The patterns rely on high-density electrode arrays, thus eliminating the issues typically associated with fixed segmented architectures and ensuring uniformity in dispensing across a variety of droplet sizes while allowing to dynamically account for leftover liquid in the reservoir. The reservoir and neck are shaped to define a desired droplet size and achieve a clean dispense with high accuracy and reproducibility. After formation of the neck several strategies are available to cleave depending on the droplet properties.

The dispensing approach of the present application reduces failure rates in multi-step droplet operations, for example in complex assays, thereby increasing the reliability of EWoD microfluidic cartridges. The range of reagents that may be used on a digital microfluidics device is also increased, thus improving the range of feasible applications. Also ensured is a high reproducibility for parallel assays conducted at a variety of volume scales, improving the parallelization capabilities of the device especially at low liquid volumes.

In an example embodiment, the bottom plate of the microfluidic device includes an active matrix electrowetting on dielectric (AM-EWoD) array featuring a plurality of elements, each array element including a propulsion electrode, although other configurations for driving the bottom plate electrodes are also contemplated. The AM-EWoD matrix may be in the form of a transistor active matrix backplane, for example a thin film transistor (TFT) backplane where each propulsion electrode is operably attached to a transistor and capacitor actively maintaining the electrode state while the electrodes of other array elements are being addressed. Top electrode circuitry may independently drive the top plate electrode.

A propulsion voltage may be defined by a voltage difference between an array electrode and the top electrode across the microfluidic region. By adjusting the frequency and amplitude of the signals driving the array electrodes and top electrode, the propulsion voltage of each pixel of the array may be controlled to operate the AM-EWoD device at different modes of operation in accordance with different droplet manipulation operations to be performed. In one embodiment, the TFT array may be implemented with amorphous silicon (a-Si), thereby reducing the cost of production to the point that the devices can be disposable.

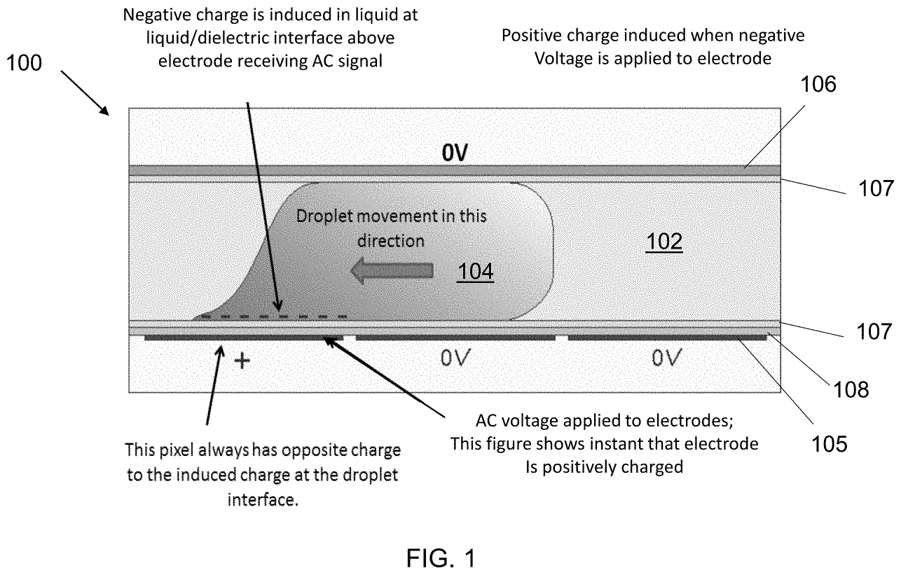

The basic operation of a typical EWoD device is illustrated in the sectional image of FIG. 1. The EWoD 100 includes a microfluidic region filled with a filler fluid 102, and at least one aqueous droplet 104. Typically, a non-polar filler fluid is used for operations on aqueous droplets. The non-polar fluid may be a hydrocarbon such as dodecane, a silicone oil, or other non-polar, long-chain organic fluid. The microfluidic region gap depends on the size of droplets to be handled and is typically in the range 50 to 200 μm, but the gap can be larger. In the basic configuration of FIG. 1, a plurality of propulsion electrodes 105 are disposed on one substrate and a common top electrode 106 is disposed on the opposing surface. The device additionally includes hydrophobic coatings 107 on the surfaces contacting the oil layer, as well as a dielectric layer 108 between the propulsion electrodes 105 and the hydrophobic coating 107. (The upper substrate may also include a dielectric layer, but it is not shown in FIG. 1). The hydrophobic layer prevents the droplet from wetting the surface. When no voltage differential is applied between adjacent electrodes, the droplet will maintain a spheroidal shape to minimize contact with the hydrophobic surfaces (oil and hydrophobic layer). Because the droplets do not wet the surface, they are less likely to contaminate the surface or interact with other droplets except when that behavior is desired.

While it is possible to have a single layer for both the dielectric and hydrophobic functions, such layers typically require thick inorganic layers (to prevent pinholes) with resulting low dielectric constants, thereby requiring more than 100V for droplet movement. To achieve low voltage propulsion, it is often better to have a thin inorganic layer for high capacitance and to be pinhole free, topped by a thin organic hydrophobic layer. With this combination it is possible to have electrowetting operation with voltages in the range +/−10 to +/−50V, which is in the range that can be supplied by conventional TFT arrays.

Hydrophobic layers may be manufactured from hydrophobic materials formed into coatings by deposition onto a surface via suitable techniques. Depending on the hydrophobic material to be applied, example deposition techniques include spin coating, molecular vapor deposition, and chemical vapor deposition. Hydrophobic layers may be more or less wettable as usually defined by their respective contact angles. Unless otherwise specified, angles are herein measured in degrees (°) or radians (rad), according to context. For the purpose of measuring the hydrophobicity of a surface, the term “contact angle” is understood to refer to the contact angle of the surface in relation to deionized (DI) water. If water has a contact angle between 0°<θ<90°, then the surface is classed as hydrophilic, whereas a surface producing a contact angle between 90°<θ<180° is considered hydrophobic. Usually, moderate contact angles are considered to fall in the range from about 90° to about 120°, while high contact angles are typically considered to fall in the range from about 120° to about 150°. In instances where the contact angle is 150°<θ then the surface is commonly known as superhydrophobic or ultrahydrophobic. Surface wettabilities may be measured by analytical methods well known in the art, for instance by dispensing a droplet on the surface and performing contact angle measurements using a contact angle goniometer. Anisotropic hydrophobicity may be examined by tilting substrates with gradient surface wettability along the transverse axis of the pattern and examining the minimal tilting angle that can move a droplet.

Hydrophobic layers of moderate contact angle typically include one or a blend of fluoropolymers, such as PTFE (polytetrafluoroethylene), FEP (fluorinated ethylene propylene), PVF (polyvinylfluoride), PVDF (polyvinylidene fluoride), PCTFE (polychlorotrifluoroethylene), PFA (perfluoroalkoxy polymer), FEP (fluorinated ethylenepropylene), ETFE (polyethylenetetrafluoroethylene), and ECTFE (polyethylenechlorotrifluoroethylene). Commercially available fluoropolymers include Cytop® (AGC Chemicals, Exton, Pa.), Teflon® AF (Chemours, Wilmington, Del.) and FluoroPel™ coatings from Cytonix (Beltsville, Md.). An advantage of fluoropolymer films is that they can be highly inert and can remain hydrophobic even after exposure to oxidizing treatments such as corona treatment and plasma oxidation.

When a voltage differential is applied between adjacent electrodes, the voltage on one electrode attracts opposite charges in the droplet at the dielectric-to-droplet interface, and the droplet moves toward this electrode, also as illustrated in FIG. 1. The voltages needed for acceptable droplet propulsion depend on the properties of the dielectric and hydrophobic layers. AC driving is used to reduce degradation of the droplets, dielectrics, and electrodes by various electrochemistries. Operational frequencies for EWoD can be in the range 100 Hz to 1 MHz, but lower frequencies of 1 kHz or lower are preferred for use with TFTs that have limited speed of operation.

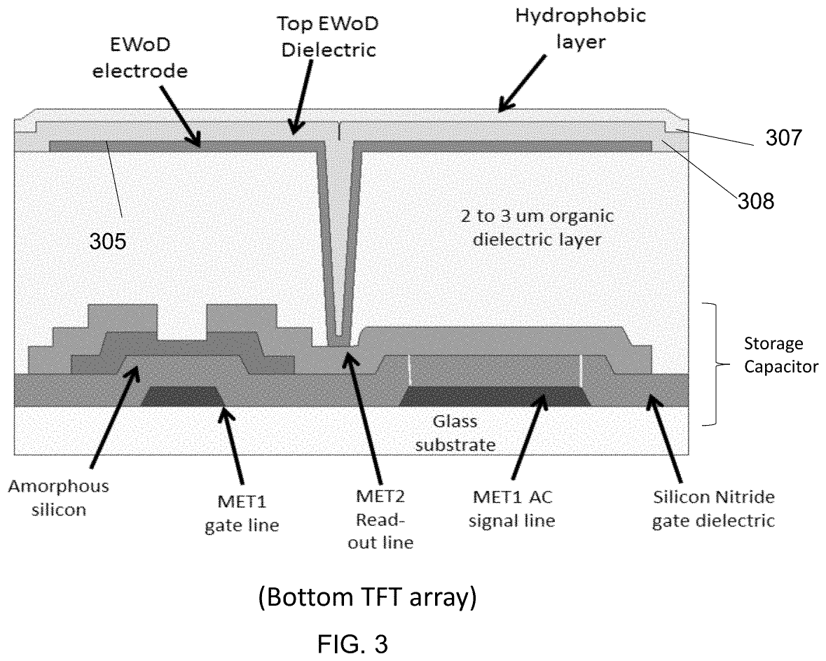

Returning to FIG. 1, the top electrode 106 is a single conducting layer normally set to zero volts or a common voltage value (VCOM) to take into account offset voltages on the propulsion electrodes 105 due to capacitive kickback from the TFTs that are used to switch the voltage on the electrodes (see FIG. 3). The top electrode can also have a square wave applied to increase the voltage across the liquid. Such an arrangement allows lower propulsion voltages to be used for the TFT connected propulsion electrodes 105 because the top plate voltage 106 is additional to the voltage supplied by the TFT.

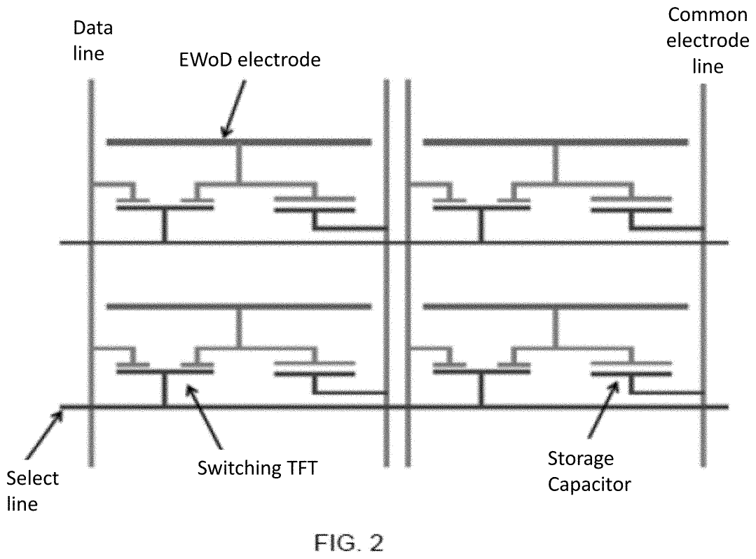

As illustrated in FIG. 2, an active matrix of propulsion electrodes can be arranged to be driven with data and gate (select) lines much like an active matrix in a liquid crystal display. The gate (select) lines are scanned for line-at-a time addressing, while the data lines carry the voltage to be transferred to propulsion electrodes for electrowetting operation. If no movement is needed, or if a droplet is meant to move away from a propulsion electrode, then 0V will be applied to that (non-target) propulsion electrode. If a droplet is meant to move toward a propulsion electrode, an AC voltage will be applied to that (target) propulsion electrode.

The architecture of an amorphous silicon, TFT-switched, propulsion electrode is shown in FIG. 3. The dielectric 308 must be thin enough and have a dielectric constant compatible with low voltage AC driving, such as available from conventional image controllers for LCD displays. For example, the dielectric layer may comprise a layer of approximately 20-40 nm SiO₂ over-coated with 200-400 nm plasma-deposited silicon nitride. Alternatively, the dielectric may comprise atomic-layer-deposited Al₂O₃ between 2 and 100 nm thick, preferably between 20 and 60 nm thick. The TFT may be constructed by creating alternating layers of differently-doped a-Si structures along with various electrode lines, with methods known to those of skill in the art. The hydrophobic layer 307 can be constructed from the materials listed above, such as Teflon® AF and FlurorPel™, which can be spin coated over the dielectric layer 308.

Circuitry for connecting and/or controlling the voltages of the top plate and bottom plate electrode may be housed in the top plate itself, in the bottom plate, for example on the edges of the electrode array, or elsewhere in the device depending on the needs and constraints of the application at hand. As stated above, Cho et al. (Journal of Microelectromechanical Systems, Volume: 12, Issue: 1, February 2003) provide a physical analysis of how basic droplet operations occur on a traditional electrowetting device.

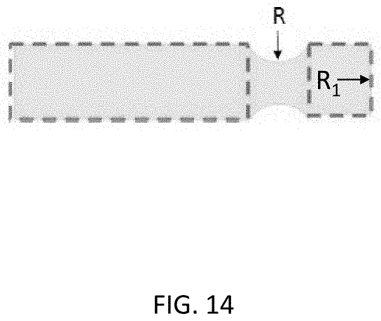

FIG. 14 schematically describes how a droplet may be cut by selective actuation of the EWoD electrodes. When cutting is in order, the head of the neck is pinched in the longitudinal direction by actuating the electrodes on either side and keeping the middle one non-energized, thus pinching in the middle. During pinching, the left and right electrodes are energized so the contact angles above them are reduced, resulting in an increase of the curvature radius R₁. In the meantime, the electrode(s) at the pinching point is floated or grounded, keeping the middle section hydrophobic. As a result, the meniscus on the middle electrode starts to contract to keep the total volume of the neck constant. That is, cutting is initiated by the elongation of the droplet in the longitudinal direction and necking (negative curvature radius R, also shown in FIG. 14) in the middle of the droplet. It can be demonstrated that the ratio of curvature radii R and R_{I} follows Equation (1):

$$\frac{R}{{R}_{1}} = 1 - ( \frac{R}{d} ) \frac{{ϵ}_{0} ϵ {V}_{a}^{2}}{2 γ t} \qquad Equation ( 1 )$$

where ∈₀ is the permittivity of vacuum, ∈ the dielectric constant of the dielectric layer, t the thickness of the dielectric layer, V_{d} the applied voltage, d the height of the microfluidic region gap, and γ the surface tension between the droplet and the filler fluid (see Cho et al.).

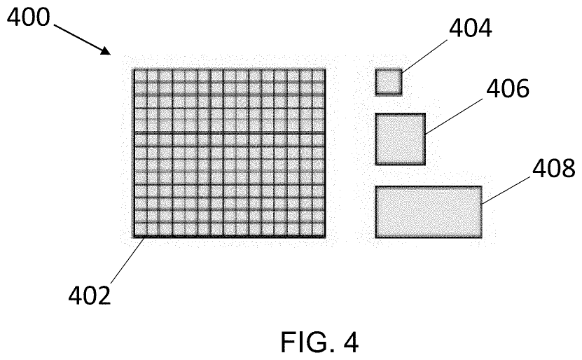

Also as stated above, dispense driving sequences according to the present application take advantage of high-density electrode arrays. FIG. 4 is a schematic top view of a reservoir 400 as defined by a high-density electrode grid 402. For example, a zone having an area of 1 in² and a bottom plate electrode density resolution of 100 PPI will encompass 100 propulsion electrodes. The same area at a higher resolution, for example 200 PPI or more, will result in a zone having 200 or more propulsion electrodes. It can be seen that the density of the electrode grid is such that its pixels have a dimension, such as the width, height, or diagonal, less than the diameter of the droplets, which allows for the dispensing of droplets of different sizes and aspect ratios. For example, droplet 404 is equivalent in width and height to a square formed by four electrodes, droplet 406 is larger and equivalent to eight electrodes, and droplet 408 has the same height as droplet 406 but is twice as wide, resulting in a rectangular shape with an aspect ratio of 2:1. However, embodiments featuring single-electrode droplets are also contemplated.

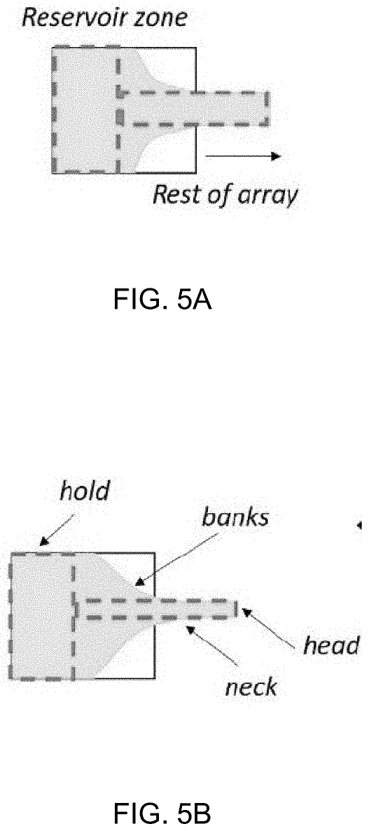

FIG. 5A is a top view of the reservoir of FIG. 4, with the electrode grid no longer shown for clarity, and a first actuated neck height.

FIG. 5B is a top view of the reservoir of FIG. 4, with the electrode grid no longer shown for clarity, and a second actuated neck height. The dashed lines represent areas of electrode actuation. It can be seen that FIG. 5A and FIG. 5B differ by the height of the actuated neck, i.e., the long extended portion. An area of the reservoir where electrode actuation takes place is defined as the “hold”, which is needed to prevent the aqueous fluid from moving uncontrollably away from the reservoir region. A portion of the fluid is driven outside the reservoir, to form an actuated “neck”, i.e., an extended region terminating at the “head”, which is the advancing edge of the fluid. It can be seen that “banks” form on either side of the neck due to excess fluid not contained within the dispense pattern. Ideally, the goal would be to minimize the formation of banks while allowing the neck to freely extend and a droplet to be separated from the head.

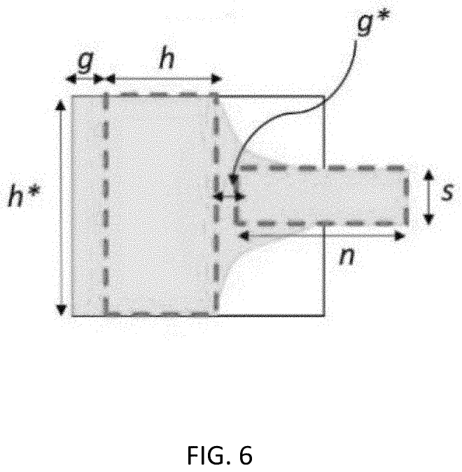

Actuation parameters including those illustrated in FIG. 6 may be used in planning and implementing electrode driving sequences for executing the dispense of a droplet having a desired size and aspect ratio. The values of each parameter may be calculated to account for the shape and other characteristics of the reservoir, droplet, neck, and hold. Each of these features and its related parameters are examined in turn.

Reservoir: the reservoir is specified to have some area equal to the length of the reservoir (L_{R}) multiplied by width (L_{R}·W_{R}), where the width of the reservoir (W_{R}) is parallel to the direction of dispense. Reservoir fluids will typically be aqueous and contain a surfactant, buffers, proteins such as enzymes, nucleic acid molecules, or other compounds. Dispensing is not limited to aqueous fluids, but other solvents and solutes as well, such as alcohols, ethers, ketones, aldehydes, etc., through precise tuning of the parameters disclosed herein.

Droplet Size: the size of the droplet may be provided in terms of droplet volume or droplet diameter. Alternatively, it may be specified in terms of the pixel area covered by the droplet on the device surface, for example as calculated by multiplying the length of the area by its height. In one embodiment, the user may input a specific droplet volume to a device programmed to calculate its corresponding area. In instances where a drop having a footprint that is as square as possible is desired, its area may be calculated according to the following algorithm:

(1) Calculate square root of volume, to obtain value “X”
(2) Round to floor, for example \sqrt{50}≅7
(3) Perform the calculation: X·X, (X+1)·(X−1), X(X+1)
(4) Whichever result is closest to the initial volume becomes the droplet dimension, for example by setting L_{D}=X and W_{D}=X+1
(5) Usually, the dimension in the direction orthogonal to that of dispense is the smallest, and is referred to herein as head height “s”.

Neck Parameters: in addition to head height s, the neck is define by neck length “n” which may be set by a user or calculated by the device. The value of n should be kept within reason so as not to exceed the volume limitations of the reservoir. Typically, the product n·s should not exceed a threshold percentage of the reservoir volume, for example 80% or less. Parameter “g*” marks the length of the gap between the position where the neck begins, relative to the edge of the hold, and may, in principle, be zero or negative, so that the neck begins at the edge of the hold or even behind it.

Hold Parameters: hold length “h” should be set bearing in mind the volume of the reservoir. Typically, h is equal to about 10%-20% of the area occupied by the reservoir fluid when the hold extends across the full vertical dimension L_{R}. Hold length h may be varied to account for reservoir fluid volume changes, but also to control the size of the banks based on droplet size. In one embodiment, h scales in proportion to 1/D², where D is the droplet diameter, to tighten the banks when dispensing smaller droplets.

Parameter “g” defines an adjustment spacing for the hold that is used to adjust for the diminishing amount of fluid in the reservoir and keep the hold placed where the remaining fluid is located. For example, if g was always equal to zero, eventually it would no longer be possible to hold the reservoir fluid in place. Parameter “h*” defines the height of the hold in instances where it differs from L_{R}. The value of h* may need to be reduced at the beginning of the dispense driving sequence due to a reduction in overall fluid volume. This will allow to center the fluid about the intended location for the formation of the neck. This height h* may also be changed when pinching off and/or cleaving the droplet, and may be increased above its dispense value as per Equation (1). The gap between hold and neck g* may be varied to deal with more viscous or problematic fluids, such that there is less restrictive actuation across the reservoir. In one non-limiting embodiment, the length of the neck n scales in proportion to 1/D to enable improved droplet dispensing at lower sizes. In another non-limiting embodiment, the head height s scales in proportion to D to enable the dispensing of droplets of different sizes.

Size Ranges and Limitations: typically, electrowetting arrays feature a grid of square pixels spaced in a regular pattern. However, the methods disclosed in the present application may be practiced on grid patterns based on electrodes and/or pixels of differing geometries, for example triangular, rectangular, or hexagonal, and of varying sizes, provided that spatial and temporal necking as disclosed herein is still feasible. Pixel sizes can vary for TFT architectures, but there is no fundamental limit to ensure reservoir operation. Typical values for pixels range between 100 micron to 1 mm pixel lengths, but can expand beyond this range. Likewise, the array may be comprised of variable resolution zones, to ensure finer sizing (e.g., a finer cleaving zone to invoke separation of the neck from the droplet, through parameters like s*, as described below).

Reservoir, hold, neck, and droplet sizes may be specified in terms of surface area as measured in number of pixels. The volume of a droplet usually should not exceed about 30% of the reservoir volume, as dispense is likely to prove problematic at larger volumes. The operating temperature range of the array should preferably not be exceeded. Likewise, freezing points and boiling points of the liquids in question should preferably not be exceeded. Typical ranges for aqueous formulations can span from 4° C. to 95° C.

The processing unit may calculate each of the actuation parameters by applying the user inputs to reference correlations saved to a memory unit. By way of example, in embodiments where the length of the actuated neck n scales in proportion to 1/D, the processing unit of the device may apply a reference correlation in the form of Equation (2):

$$n = a + \frac{b}{D} \qquad Equation ( 2 )$$

where a and b are constants specific to the reference correlation which may vary according to the type of fluid used and other characteristics of the application at hand, such as measured temperatures or surface tensions. In some instances the equation may include terms proportional to other powers of D, for example 1/D² or D^{1/2} and/or additional terms dependent from other variables specific to the application. Similar considerations apply to algorithm steps for calculating the length of the actuated hold and the height of the actuated neck.

Images corresponding to a reservoir dispense event may be generated as an implementation of user inputs and calculated actuation parameters in a manner similar to an animation composed of sequential steps. In some embodiments, a code is assigned to active pixels vs. inactive pixels. The inactive pixels will ultimately receive no voltage pulses, while the active pixels will receive a collection of voltage pulses for each output image, herein called the “waveform”. The images are then transferred to the controller in the form of waveforms specifying the voltage pulses to apply to the active pixels.

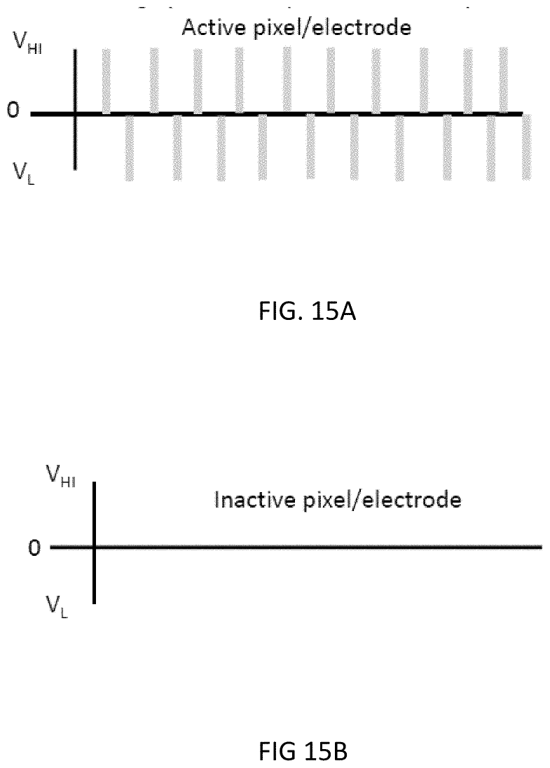

In active matrix devices, the controller uses active matrix scanning to drive the pixels to their respective voltages. Each image corresponds to an individual step in the reservoir dispense routine. The routing may last multiple steps/images until the droplet is dispensed. Each image is implemented by a number of voltage pulses, or “frames,” where active pixels are driven to a set voltage while inactive pixels are typically kept at 0 V. The voltage pulses may span a given positive or negative range, typically within ±30 V or ±40 V on TFT arrays. As illustrated in FIG. 15A, driving sequences may include both positive and negative voltages pulses. The frequency of a voltage pulse is defined by how long an active pixel receives a voltage pulse of a specific voltage and polarity. As illustrated in FIG. 15B, there are no driving sequences thereby rendering the electrodes inactive.

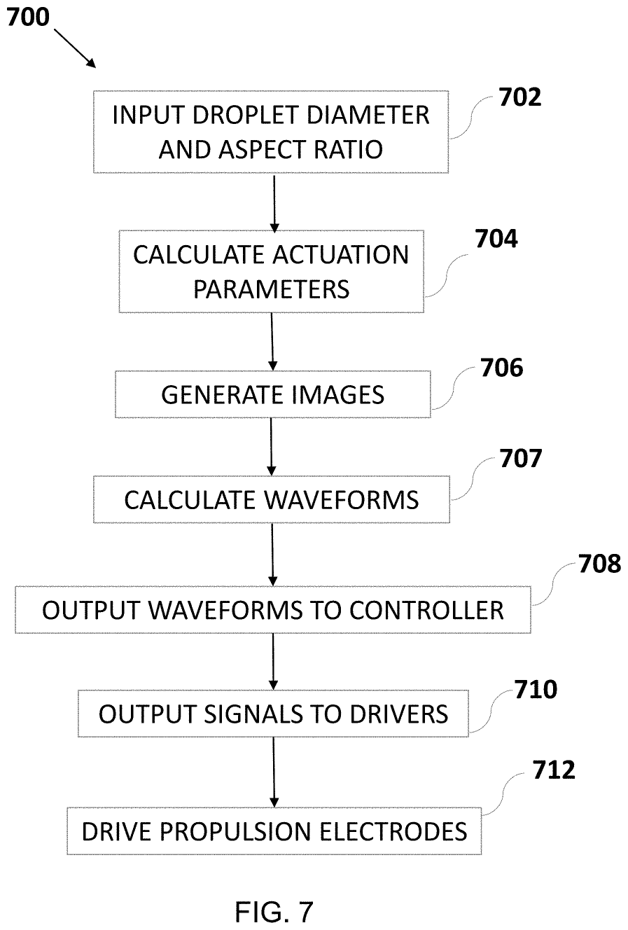

The flow chart of FIG. 7 illustrates an example droplet dispense process 700 whereby electrode driving sequences for specific top plate and bottom plate electrodes can be calculated and implemented based on the diameter and aspect ratio of a droplet to be dispensed in a microfluidic system. In step 702, a user inputs a desired droplet diameter and aspect ratio in the form of instructions which are stored in a computer-readable medium that is accessed by a processing unit of the device. The user may also input other relevant variables affecting the actuation parameters, such as the viscosity and surface tension of the aqueous fluid of the droplet.

The instructions cause the processing unit to execute an algorithm stored in a computer-readable medium and calculate actuation parameters specific to the characteristics of the desired droplet, including neck and hold parameters such as the width of the hold, the length of the neck, and the height of the head (704). Each parameter may be calculated as a function of the input variables according to one or more reference correlations that may be saved to a memory location under control of the processing unit or input by the user at a point prior or during the dispense process.

The processing unit then generates images corresponding to the dispense (706) and the polarity, frequency, and amplitude of each of the pulses of corresponding waveforms are calculated (707). Then, the processing unit outputs the waveforms to a controller (708), and the controller outputs signals to the drivers of the propulsion electrodes (710). In instances where the bottom plate includes an array of TFT electrodes, the controller outputs gate line signals to the drivers of gate lines and data line signals to data line drivers, thereby driving the intended propulsion electrodes. The selected propulsion electrodes are then driven to perform the driving sequence dispensing the droplet (712).

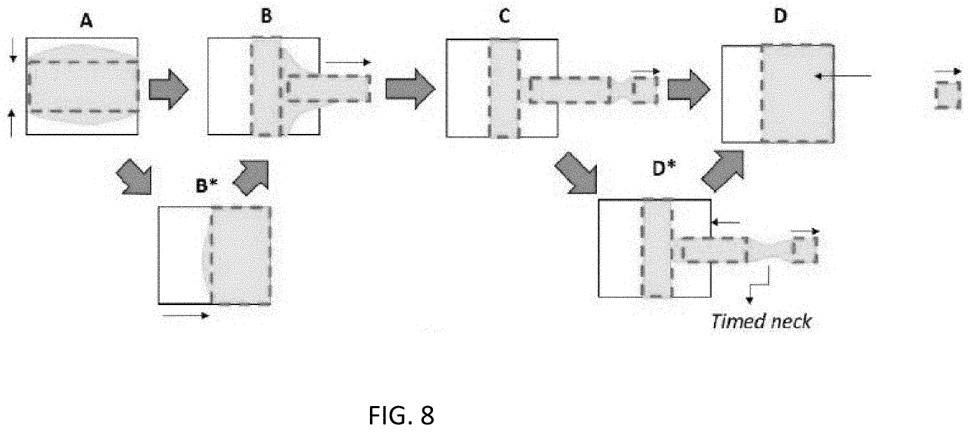

FIG. 8 is a schematic illustration of an exemplary dispense pattern starting with configuration A, where the fluid is collected vertically towards the center. In optional configuration B* the fluid is moved to the front of the reservoir, and in configuration B the hold and the neck are formed. Then, in configuration C, cleaving of a droplet from the head commences. In optional configuration D* the droplet is afforded additional steps to be moved away from the head prior to pulling the neck back to the reservoir, herein referred to as the “timed neck” phase. Finally, in configuration D the reservoir is reformed and the droplet is moved farther away.

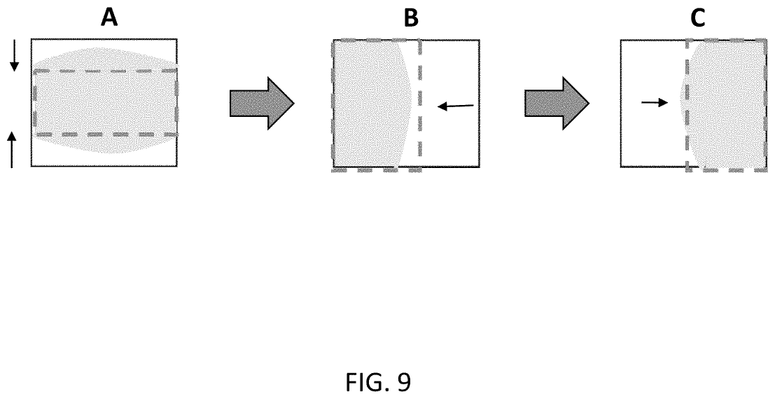

FIGS. 9-13 illustrate the individual phases of the dispense pattern of FIG. 8. Illustrated in FIG. 9 is Phase 1, involving a number of operations to center the fluid in the reservoir. This may be achieved by centering it vertically (A) and then collecting any liquid from the back (B) and moving it to the front (C). Usually, liquid being at the front of the designated reservoir zone is the preferred starting point for a dispense operation. The size of the centering patterns (shown in magenta) typically extend at least one full length or width of the reservoir zone, where the other dimension scales with the remaining volume of the reservoir, being large enough to extend at least 20% past the liquid edge in the case of B and C. For vertical centering (or the direction orthogonal to the dispense), a centered pattern covers the length (horizontal) of the reservoir and approximately 50% of the vertical space. Note that reservoirs may be positioned to dispense both vertically and horizontally so these definitions may change depending on orientation.

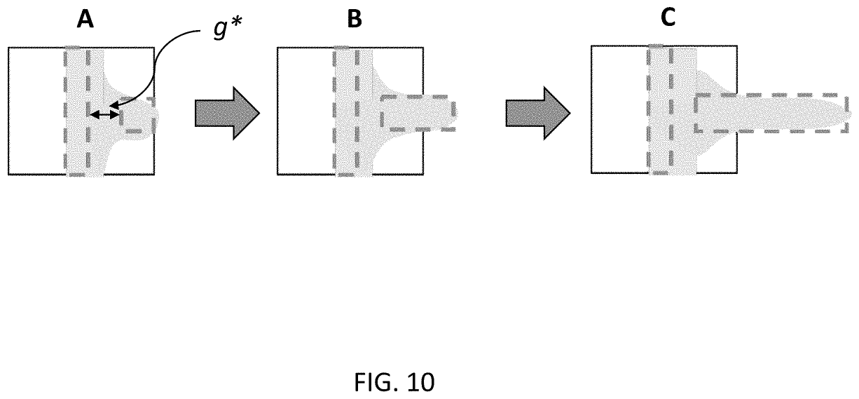

FIG. 10 illustrates Phase 2, where the hold and neck are created followed by stretching of the neck. As disclosed above, several actuation parameters are linked to the hold and neck. The neck starts short (about the size of the target droplet), and then extends outward in the dispense direction until it reaches the specified neck length. The neck is centered about the vertical direction, and, as stated above, the value for parameter g* may be such that the neck begins right at the edge of the hold. Typically, the neck extends in the dispense direction by a distance equal to about one half of the desired droplet diameter. However, this value may be as small as a single pixel electrode.

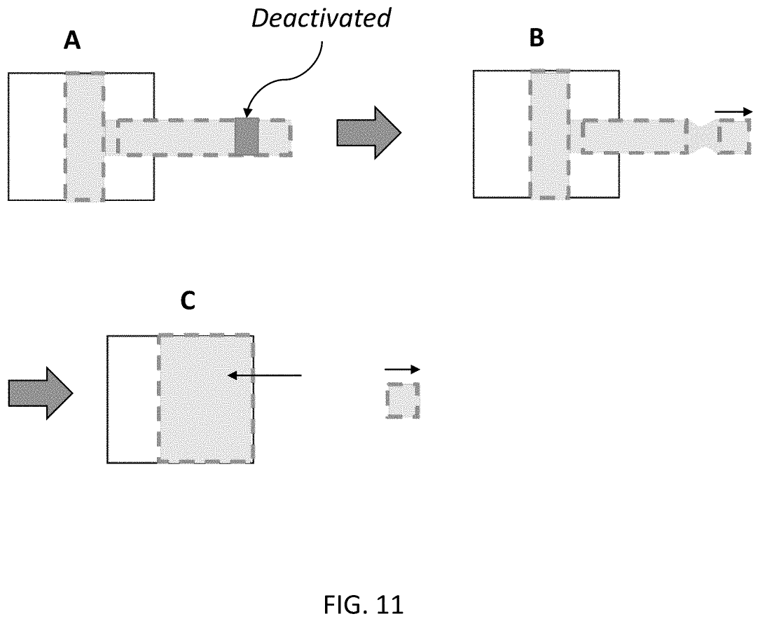

FIG. 11 illustrates Phase 3, the cleaving of the droplet that commences once the neck is fully outstretched. An area is designated to be deactivated that separates the reservoir liquid from the desired droplet, shown in red. To initiate the cleave, the area is deactivated, either by floating or grounding the electrode(s) in the area (A), and the droplet is continued to be moved to the right by a minimum step of typically one pixel, with a typical step of one half of a pixel size in the direction of dispense (B). The final step is to draw back the reservoir by actuation of an area equivalent to the fluid remaining in the neck that fully spans the direction orthogonal to that of the dispense. At the same time, the droplet is moved further away from the reservoir (C).

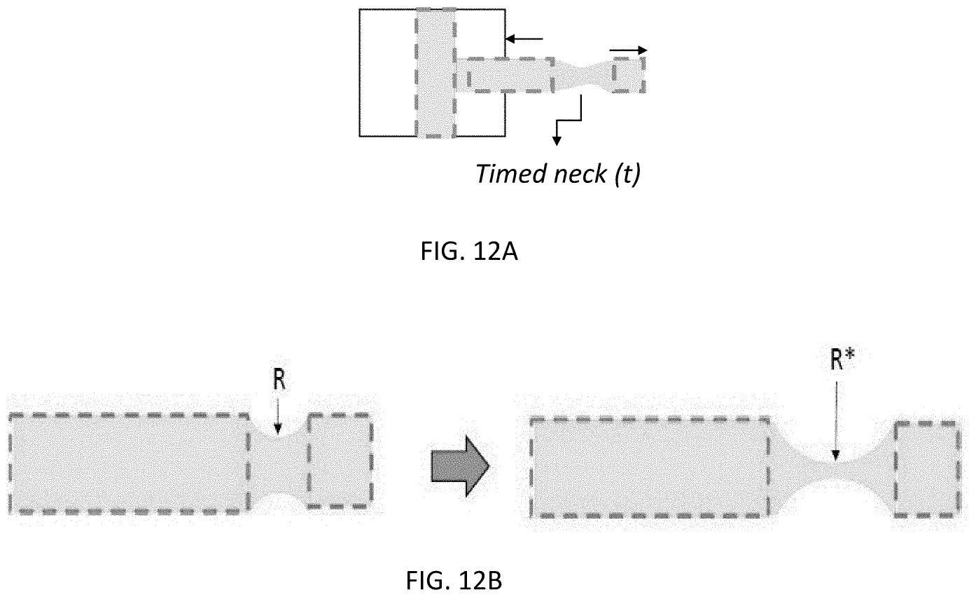

In a variation of Phase 3 as illustrated in FIG. 12A, step B is increased by a number of steps and the droplet is moved further away before pulling back the reservoir, thereby forming an extended “timed neck”. By this strategy, the negative curvature radius R is increased to R* which aids in cleaving the droplet (FIG. 12B). Parameter “t” defines the extra number of steps that may be used for the droplet dispense before pulling the neck back to the reservoir.

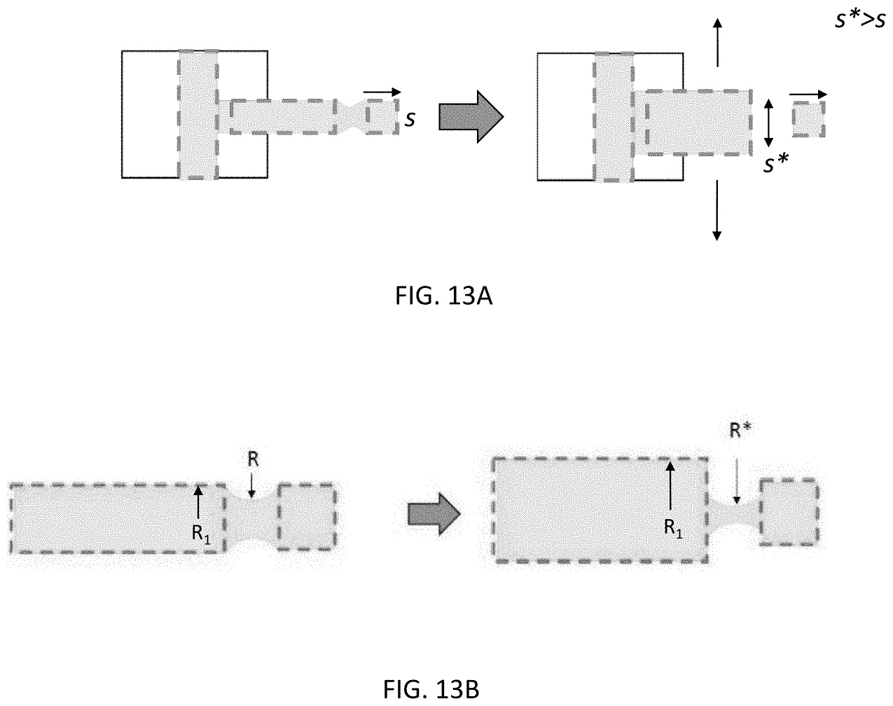

In a further variation of Phase 3, as illustrated in FIG. 13A, the ability of necking in two dimensions afforded by high-density electrodes may be used to achieve improved control over the droplet cleaving step. Specifically, the head height s, that is, the dimension of the advancing neck that is orthogonal to the direction of neck advancement, may be increased to a new “advanced cleave height” s* that is larger than the original by actuating electrodes on either side of the neck. As shown in Equation (1), in order to split the neck, R should be increasingly negative, thus a larger R₁ (afforded by increasing s to s*) is desirable in order to obtain a more effective cleaving (FIG. 13B). Parameter “s*” may be termed as the new height of the side of the neck orthogonal to the direction of dispense. The extent by which s* is greater than s may be specified in terms of pixel electrodes or as a percentage of the original head height s.

It will be apparent to those skilled in the art that numerous changes and modifications can be made in the specific embodiments of the invention described above without departing from the scope of the invention. Accordingly, the whole of the foregoing description is to be interpreted in an illustrative and not in a limitative sense.

All of the contents of the aforementioned patents and applications are incorporated by reference herein in their entireties. In the event of any inconsistency between the content of this application and any of the patents and application incorporated by reference herein, the content of this application shall control to the extent necessary to resolve such inconsistency.

1. A method of dispensing a droplet on a digital microfluidic system,
the system comprising:
a bottom plate comprising:
a bottom electrode array comprising a plurality of digital microfluidic propulsion electrodes; and
a first dielectric layer covering the bottom electrode array;
a top plate comprising:
a common top electrode; and
a second dielectric layer covering the common top electrode;
a processing unit operably programmed to perform a microfluidic driving method; and
a controller operatively coupled to the processing unit, common top electrode, and bottom electrode array, wherein the controller is configured to provide propulsion voltages between the common top electrode and the bottom plate propulsion electrodes;
the microfluidic driving method comprising:
receiving input instructions in the processing unit, the input instructions relating to a droplet diameter and an aspect ratio;
calculating in the processing unit actuation parameters comprising: a length of an actuated hold, a length of an actuated neck, and a height of an actuated head, for dispensing a droplet having the diameter and aspect ratio of the input instructions;
outputting electrode actuation instructions from the processing unit to the controller, the electrode actuation instructions relating to a dispense driving sequence for implementing the calculated actuation parameters;
executing the dispense driving sequence on the propulsion electrodes, to:
shape a fluid in a reservoir to form an actuated hold and an actuated neck;
cleaving the droplet from the head of the neck; and
returning the neck fluid into the reservoir,
wherein the electrodes have a dimension less than the diameter of the droplet.

2. The method of dispensing a droplet of claim 1, wherein the length of the actuated hold is calculated according to an equation responsive to at least the input droplet diameter and correlating the droplet diameter to the length of the actuated hold.

3. The method of dispensing a droplet of claim 1, wherein the length of the actuated neck is calculated according to an equation responsive to at least the input droplet diameter and correlating the droplet diameter to the length of the actuated neck.

4. The method of dispensing a droplet of claim 1, wherein the height of the actuated head is calculated according to an equation responsive to at least the input droplet diameter and correlating the droplet diameter to the height of the actuated neck.

5. The method of dispensing a droplet of claim 1, wherein the actuation parameters further comprise one or more of a reservoir height, an adjustment space for the hold, a length of the actuated hold, a height of the actuated neck, a hold spacing, an amount of leftover fluid in the reservoir, and a length of the gap between the actuated hold and the actuated neck.

6. The method of dispensing a droplet of claim 1, further comprising forming a timed neck to give the droplet additional time to be moved away from the neck.

7. The method of dispensing a droplet of claim 1, further comprising increasing the height of the actuated head to an advanced cleave height before cleaving the droplet from the head of the neck.

8. The method of dispensing a droplet of claim 1, further comprising reducing the height of the hold to center the fluid about the location where the neck is formed.

9. A digital microfluidic system, comprising:
a bottom plate comprising:
a bottom electrode array comprising a plurality of digital microfluidic propulsion electrodes; and
a first dielectric layer covering the bottom electrode array;
a top plate comprising:
a common top electrode; and
a second dielectric layer covering the common top electrode;
a processing unit;
a controller operatively coupled to the processing unit, common top electrode, and bottom electrode array, wherein the controller is configured to provide propulsion voltages between the common top electrode and the bottom plate propulsion electrodes; and
wherein the processing unit operably programmed to:
receiving input instructions, the input instructions relating to a droplet diameter and aspect ratio;
calculating actuation parameters comprising: a length of an actuated hold, a length of an actuated neck, and a height of an actuated head, for dispensing a droplet having the diameter and aspect ratio of the input instructions;
outputting electrode actuation to the controller, the electrode actuation instructions relating to a dispense driving sequence for implementing the calculated actuation parameters, to dispense having the input diameter and aspect ratio;
wherein the electrodes have a dimension less than the diameter of the droplet.

10. The digital microfluidic system of claim 9, wherein the processing unit is operably programmed to calculate the length of the actuated hold according to an equation responsive to at least the input droplet diameter and correlating the droplet diameter to the length of the actuated hold.

11. The digital microfluidic system of claim 9, wherein the processing unit is operably programmed to calculate the length of the actuated neck according to an equation responsive to at least the input droplet diameter and correlating the droplet diameter to the length of the actuated neck.

12. The digital microfluidic system of claim 9, wherein the processing unit is operably programmed to calculate the height of the actuated head with an equation responsive to at least the input droplet diameter and correlating the droplet diameter to the height of the actuated head.

13. The digital microfluidic system of claim 9, wherein the actuation parameters further comprise one or more of a reservoir height, an adjustment space for the hold, a length of the actuated hold, a height of the actuated neck, a hold spacing, an amount of leftover fluid in the reservoir, and a length of the gap between the actuated hold and the actuated neck.

14. The digital microfluidic system of claim 9, wherein the processing unit is further operably programmed to form a timed neck to afford the droplet additional time to be moved away from the neck.

15. The digital microfluidic system of claim 9, wherein the processing unit is further operably programmed to increase the height of the actuated head to an advanced cleave height before cleaving the droplet from the head of the neck.

16. The digital microfluidic system of claim 9, wherein the processing unit is further operably programmed reduce the height of the hold to center the fluid about the location where the neck is formed.

17. The digital microfluidic system of claim 9, wherein the bottom plate further comprises a transistor active matrix backplane, each transistor of the backplane being operably connected to a gate driver, a data line driver, and a propulsion electrode.

18. The digital microfluidic device of claim 17, wherein the transistors of the backplane are thin film transistors (TFT).

19. In a method of dispensing a droplet on a digital microfluidic system, the method comprising extending a line of liquid from a reservoir, forming an actuated neck between the reservoir and the incipient droplet, and cleaving the droplet from the actuated head of the neck, the improvement comprising: increasing the height of the actuated head to an advanced cleave height before cleaving the droplet from the head.
